(19) United States
(12) Patent Application Publication
(10) Pub. No.: US 2022/0057755 A1
(43) Pub. Date: Feb. 24, 2022

(54) WRIST WATCH ALLOWING FOR MOBILE PHONE CASE ATTACHMENT

(71) Applicants: Michael Konig, Hoboken, NJ (US); Betsabe Jusino, Hoboken, NJ (US)

(72) Inventors: Michael Konig, Hoboken, NJ (US); Betsabe Jusino, Hoboken, NJ (US)

(21) Appl. No.: 17/406,041

(22) Filed: Aug. 18, 2021

Related U.S. Application Data
(60) Provisional application No. 63/067,500, filed on Aug. 19, 2020.

(51) Int. Cl. G04B 37/14; H04B 1/3827; H04M 1/04

(52) U.S. Cl. CPC G04B 37/1413; H04B 2001/3861; H04M 1/04; H04B 1/385

(57) ABSTRACT

An exemplary wearable mobile device attachment article comprises a mobile device cover with a first face and a second face opposite the first face. An exemplary first face may be configured to provide access to the screen of a mobile device. A receptacle may project outwardly from the second face while a wearable article has at least one surface for frictionally engaging the mobile device cover.

### RELATED APPLICATION DATA

This application claims the benefit of priority of U.S. Provisional Patent Application Ser. No. 63/067,500, filed on Aug. 19, 2020, the disclosures of which are incorporated herein by reference in their entirety.

### BACKGROUND

### I. Field Of The Invention

The present invention relates to an improved wristwatch capable of attaching to a mobile phone case, wherein the face/body of a wrist watch may be designed in a way that allows the removable case of a mobile phone to attach (interlock) directly on top of the face of the watch, or to improved mobile phone cases that allow for attachment to existing wrist watches, so that the mobile phone may be held in place on the user's wrist, and the user may be able to easily and/or quickly secure or remove the mobile phone to or from the user's wrist watch.

### II. Background of the Related Art

Smartphones/mobile phones may be used by individuals throughout their day. Smartphones/mobile phones may be used to make phone calls, respond to emails, and browse the Internet, among other uses. As the overall functionality of mobile phones increases, so does their need to become more user-friendly and easier to carry and/or use throughout the day. Mobile phones can be large and bulky to carry. Mobile phones typically require both hands in order to carry out most functions on the phone. As a result many users find themselves carrying their mobile phones in hand as they go about their daily activities. Constantly holding a phone in one hand, however, can limit user productivity, making it more difficult to accomplish tasks that require both hands, and there is always the possibility that a phone can be dropped (and break), or that the user's ability to carry out their desired tasks will be compromised.

As a result of the above conventional obstacles, mobile phone users that need use of both hands often have to find a place to put their device down temporarily. This can expose the phone to unsanitary surfaces, or even to damage if placed on unstable surfaces. Furthermore, the size and shape of many mobile phones does not allow for a comfortable fit in the pockets of an individual's clothing. As with pockets, when an individual places their mobile phone in their purse or backpack, it can take several seconds to access. As a result, the need exists for a solution that allows a user to maintain access to their mobile phone without the need to carry the phone in hand or expose the phone to unsanitary surfaces.

In order to allow a mobile phone user to more easily access and use their phone, certain mobile phone accessories and technologies exist. For example, arm bands that hold mobile phones allow individuals to “wear” their mobile phone on their arm; holsters that attach to belts allow individuals to easily clip their mobile phone in and out of a holder that can be easily accessed; and smart watches that electronically extend the capabilities of a user's phone to the watch on their wrist without having to remove their phone from any pocket/bag may be all designed to help individuals carry/use their phone more easily.

Despite the above, none of the aforementioned technologies allow the user to maintain access to their mobile phone while also allowing the user to wear a regular wristwatch. Nor do they allow the user to secure their phone without exposure to unsanitary surfaces.

Several limitations exist to these current options for mobile phone users. Arm bands allow a user to use their mobile phone hands-free, by attaching the mobile phone to the user's arm/wrist. These designs may be relatively simple, and include a mobile case that fits over the mobile phone, which may be able to attach and/or engage with a portion of a band that may be attached to the user's arm. These arm band accessories may be perfect to use while exercising, when a user wishes to secure their mobile phone to their arm in order to listen to music or easily answer calls. These accessories do not allow a user to easily view the front screen of their phone, and do not allow a user to easily use their phone while it may be attached to their arm (for example, in order to respond to emails). In addition, these arm bands may be not suited to be worn throughout the day, as they can be uncomfortable and not suited for wearing with most clothing. In addition, due to the size of most mobile phones, these bands may be often attached to the upper arm of the wearer, which makes the phone itself more difficult to access.

Holsters may be often designed to attach to an individual's pants, jacket, or purse. Holsters often clip on to an article of clothing, or an item such as a purse or backpack or belt. The mobile phone can be clipped into and out of the holster. Holstered phones, however, cannot be used while clipped into the holster. Therefore, while they provide a more convenient place to hold the mobile phone of a user, they do not provide any additional functionality. In addition, for example, if the holster may be clipped onto a user's pants or belt, the holster must be removed and reattached when the user switches their clothing.

Smart watches allow users to electronically extend the capabilities of the wearer's phone to the watch on their wrist, have many functions, and may be less bulky. However, several limitations exist with respect to smart watches. First, smart watches need to be frequently charged, otherwise they will not function. Second, smart watches may be digital watches, and many individuals prefer the look of non-digital wristwatches, or depending on the occasion and/or dress code, choose not to wear a smart watch. Third, smart watches have a small screen size, and while they may suffice for reading text messages, playing music, and carrying out simple commands, they may be not ideal for browsing the Internet, watching videos, or responding to long emails that contain attachments. Furthermore, the electronic connection between a smart watch and the mobile phone can fail for a variety of reasons. Accordingly, there may be drawbacks to the existing methods used by individuals desirous of using their mobile phones without the need to carry them in hand. Further, there may be also a need to maintain access to a mobile phone without compromising the user's desire to also wear a fashionable wrist watch.

Therefore, there may be a need for an improved wrist watch capable of mobile phone case attachment that allows for wearing the phone case on top of a wrist watch. The invention allows an individual to wear a fashionable watch, and then easily and securely attach their mobile phone on top of the face of the watch, so that their mobile phone can be used in a hands-free manner, without compromising any functionality of the phone or limiting access to the phone's full feature set. Alternatively, an improved mobile phone case that allows for attachment to existing wrist watches also allows for hands-free use of the phone without limiting access to the phone's full feature set. Prior art solutions to this need have drawbacks, as discussed above. Accordingly, an improved wristwatch capable of attachment to a mobile phone case that may be designed in a way that allows the for the case to attach and interlock directly on top of the face of a wrist watch, so that the mobile phone may be held in place on the user's wrist, represents an improvement over the prior art.

Likewise, a mobile phone case that may be designed in a way that allows the for the case to attach and interlock directly on top of the face of a wrist watch, so that the mobile phone may be held in place on the user's wrist, represents an improvement over the prior art. Both the improved wristwatch and the improved mobile phone case allows the wearer to wear a fashionable watch, and use their mobile phone on its own, but then combine the two so that the mobile phone may be attached to the user's wrist and can be used in a hands-free manner without compromising any functionality of the phone. Accordingly, both the inventive wristwatch or the inventive phone case that secures a mobile phone to the face of a wrist watch, can be used in several situations so that an individual can easily access their mobile phone, and use it in a hands free-manner.

In addition, a phone case that has the ability to interlock with a wrist watch, whether via the inventive wristwatch or the inventive phone case, so that the mobile phone may be securely held in place on the individual's wrist may be also an improvement over the prior art because the watch can be worn on its own, serving its own purpose, unlike an arm band which may be merely used to secure a phone and serves no other purpose. Furthermore, when the mobile phone case may be easily attached to the face of the wrist watch, it can also be easily and quickly removed from the face of the watch in a matter of seconds. Therefore, throughout the day, depending on the situation or what the wearer may be doing, the mobile phone in the improved wrist watch or the improved mobile phone case can be easily attached and removed to the wrist watch without inconveniencing the wearer in any way. Accordingly, there may be a need that may be met by the respective inventions that allow for secure attachment with a mobile phone in its case to a wristwatch, so that a wearer has the option to use their phone in a hands-free manner, while it may be conveniently attached to the wearer's wrist.

### SUMMARY

The present disclosure describes both an improved wrist watch as well as an improved mobile phone case. Each may be designed in a way that allows the removable case of a mobile phone to securely attach directly to the top of the face of the wrist watch, so that the mobile phone may be held in place on the user's wrist, and the user may be able to easily and quickly secure or remove the mobile phone from the wrist watch, so that a user can use their phone in a hands-free manner without compromising any functionality of the phone, or any comfort to the wearer.

In one embodiment, the invention comprises an improved wristwatch, with a body that comprises the case as well as the lugs. Within the case of the watch may be the face of the watch, which has a watch dial and hands. Covering the face of the watch may be the crystal of the watch. Surrounding the crystal of the watch can be a raised bezel, designed to act as an attachment means to a mobile phone case. Attached to one side of the case may be a crown, used to adjust the time. The wristwatch body, can be made out of any acceptable materials, e.g., stainless steal, metal, gold, plastic, etc. Attached to the lugs of the watch (or case), may be the straps of the wristwatch. The straps of the wristwatch have a magnetic clasp that secures the straps to one another, and which can be easily adjusted so that one size fits all. The straps of the wristwatch can be made out of any acceptable materials, e.g. stainless steel, metal, gold, plastic, leather etc. and may additionally contain grooves to allow for adjustment of the strap on the user's wrist. Other well-known wrist watch embodiments may be readily known, including digital watches and the like.

The outer case of the wristwatch comprises a face. In one embodiment, the face/case of the watch extends outward, or contains a raised bezel, so that there may be a recessed space (portion) between the base and lugs of the watch and the top case of the watch. In one embodiment, the recessed portion may be configured to receive a phone case therein. Other well-known wrist watch embodiments may be readily known, including watches with rectangular faces and the like.

In one embodiment, the mobile phone case comprises an inner housing configured and dimensioned to fit securely around the entirety of a mobile phone and to protect the top, bottom, sides, and rear surfaces of the mobile phone. The mobile phone case can also be configured to accommodate or hold cash, ID's or credit cards, on either the top or bottom of the case, or on both. The mobile phone case has a window on the front side of the case allowing access to the full screen of the mobile phone. The rear protective case has a separate square portion/layer that projects outwardly, and that covers roughly a third of the back of the case and which may be positioned in the middle of the back of the case. Within the square portion on the back of the case that projects outwards may be a receptacle, which can be of any acceptable shape, within the middle of the outwardly projected layer. The receptacle may be configured to receive and/or interlock with the wristwatch. Within the separate square portion/layer, surrounding the receptacle can be latching means for securement directly with a clasp component that may be within the separate layer. The clasp component secures the case of the watch in place on the mobile phone case, and also acts as a release when detaching the mobile phone case from the watch.

The separate square portion/layer that projects outward has a cavity-like-pocket, wherein the latching means may be positioned, and wherein the clasping mechanism may be fitted. The clasping mechanism may be positioned within the cavity-like-pocket. The clasping mechanism has two longitudinal members, parallel to one another. One member sits on one side of the receptacle, and the other member sits on the other side of the receptacle. The members may be joined to a base on the left-hand side. The base of the clasp mechanism projects slightly out of the cavity-like-pocket. The base of the clasp mechanism serves as a release mechanism when detaching the mobile phone case from the watch.

In one embodiment, with slight force, the case of the watch face that extends outwardly may be fitted into the receptacle on the back of the mobile phone case. As the mobile phone case may be attached on top of the watch case, the clasp mechanism that may be fitted around the receptacle 35 tightly grips the case of the watch, ensuring that it may be held in place. The base portion, which may be attached to the longitudinal members that securely clasp the case of the watch, can be used to release the mobile phone case from the watch. The base portion, which sticks outward on the back on the case, when pushed downward, releases the clasp members and allows the mobile phone case to be easily removed from the watch.

In one embodiment the wristwatch has a circular face that engages with a circular receptacle on the back of the mobile phone case. In another embodiment, the wristwatch has a rectangular face that engages with a rectangular receptacle on the back of the mobile phone case. Any other acceptable watch face shape can engage with any other acceptable receptacle on the back of the mobile phone case.

In one embodiment the wristwatch has a magnetic Milanese clasp design that may lock the watch straps together without the need for a buckle, and can be easily adjusted so that one size fits all. In another embodiment, the wristwatch has leather, plastic, or stainless steel watch straps that may be secured with a butterfly closure. In another embodiment, the wristwatch has leather straps that may be secured together with a buckle that fastens the leather watch straps to one another. In another embodiment, the wristwatch has metal straps that unfold into thirds to allow the watch to fit over the hand, and then may be locked in placed with a deployment clasp.

An exemplary embodiment of this invention will allow users to customize the mobile phone case colors to match the color of the wrist watch.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the receptacle has a plurality of contours for frictional engagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the mobile device cover has a plurality of latches for frictional engagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the mobile device cover and the wearable article each have a plurality of contours for frictional engagement.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. This exemplary wearable mobile device attachment article may further comprise at least one release mechanism on the mobile device cover for disengagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. This exemplary wearable mobile device attachment article may further comprise at least one release mechanism on the mobile device cover for disengagement with the wearable article. This exemplary wearable mobile device attachment article may further comprise at least one release mechanism on the mobile device cover for disengagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. This exemplary wearable mobile device attachment article may further comprise at least one release mechanism on the mobile device cover for disengagement with the wearable article. This exemplary wearable mobile device attachment article may further comprise at least one release mechanism on the mobile device cover for disengagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the at least one surface of the wearable article that frictionally engages the mobile device cover resides on an adaptor coupled to the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the receptacle has a plurality of contours for frictional engagement with the wearable article.

An exemplary wearable mobile device attachment article may comprise a mobile device cover having a first face and a second face opposite the first face, the first face configured to provide access to the screen of a mobile device, a receptacle projecting outwardly from the second face, and a wearable article comprising at least one surface for frictionally engaging the mobile device cover, wherein the wearable article comprises at least one mechanism for communicating time to a user. In this exemplary wearable mobile device attachment article, the mobile device cover has at least one latch for frictional engagement with the wearable article.

An exemplary method of attaching a mobile device cover to a wearable article may comprise the steps of: aligning a receptacle projecting from a rear of a mobile device cover with at least one surface on a wearable article and friction-fitting the receptacle over the at least one surface of the wearable article, wherein the wearable article may be configured to communicate time to its wearer.

An exemplary method of attaching a mobile device cover to a wearable article may comprise the steps of: aligning a receptacle projecting from a rear of a mobile device cover with at least one surface on a wearable article and friction-fitting the receptacle over the at least one surface of the wearable article, wherein the wearable article may be configured to communicate time to its wearer. According to this exemplary method, the step of friction-fitting the receptacle over the at least one surface of the wearable article involves one of a latch on the mobile device cover, a contour in the receptacle, and a contour in the at least one surface on the wearable article.

An exemplary method of attaching a mobile device cover to a wearable article may comprise the steps of: aligning a receptacle projecting from a rear of a mobile device cover with at least one surface on a wearable article and friction-fitting the receptacle over the at least one surface of the wearable article, wherein the wearable article may be configured to communicate time to its wearer. According to this exemplary method, the step of friction-fitting the receptacle over the at least one surface of the wearable article involves the latch on the mobile device cover.

An exemplary method of attaching a mobile device cover to a wearable article may comprise the steps of: aligning a receptacle projecting from a rear of a mobile device cover with at least one surface on a wearable article and friction-fitting the receptacle over the at least one surface of the wearable article, wherein the wearable article may be configured to communicate time to its wearer. According to this exemplary method, the step of friction-fitting the receptacle over the at least one surface of the wearable article involves the contour in the receptacle.

An exemplary method of attaching a mobile device cover to a wearable article may comprise the steps of: aligning a receptacle projecting from a rear of a mobile device cover with at least one surface on a wearable article and friction-fitting the receptacle over the at least one surface of the wearable article, wherein the wearable article may be configured to communicate time to its wearer. According to this exemplary method, the step of friction-fitting the receptacle over the at least one surface of the wearable article involves the contour in the at least one surface on the wearable article.

An exemplary wearable article may comprise a body having time-communicating means, a bezel coupled to the body having a surface projecting away from the body, a top portion coupled to the bezel, wherein a recessed surface may be located between the top portion and the surface of the bezel, and at least one strap coupled to the body and configured to allow the wearable article to be worn, wherein the top portion overhangs the recess and at least a portion of the surface of the bezel.

An exemplary wearable article may comprise a body having time-communicating means, a bezel coupled to the body having a surface projecting away from the body, a top portion coupled to the bezel, wherein a recessed surface may be located between the top portion and the surface of the bezel, and at least one strap coupled to the body and configured to allow the wearable article to be worn, wherein the top portion overhangs the recess and at least a portion of the surface of the bezel. According to this exemplary embodiment, the top portion overhangs the recess and the entire surface of the bezel.

An exemplary wearable article may comprise a body having time-communicating means, a bezel coupled to the body having a surface projecting away from the body, a top portion coupled to the bezel, wherein a recessed surface may be located between the top portion and the surface of the bezel, and at least one strap coupled to the body and configured to allow the wearable article to be worn, wherein the top portion overhangs the recess and at least a portion of the surface of the bezel. According to this exemplary embodiment, the recess may be configured to receive at least one latch or at least one contour in a receptacle on a mobile device cover.

An exemplary wearable article may comprise a body having time-communicating means, a bezel coupled to the body having a surface projecting away from the body, a top portion coupled to the bezel, wherein a recessed surface may be located between the top portion and the surface of the bezel, and at least one strap coupled to the body and configured to allow the wearable article to be worn, wherein the top portion overhangs the recess and at least a portion of the surface of the bezel. According to this exemplary embodiment, the recess may be configured to receive a plurality of latches disposed on a mobile device cover.

An exemplary wearable article may comprise a body having time-communicating means, a bezel coupled to the body having a surface projecting away from the body, a top portion coupled to the bezel, wherein a recessed surface may be located between the top portion and the surface of the bezel, and at least one strap coupled to the body and configured to allow the wearable article to be worn, wherein the top portion overhangs the recess and at least a portion of the surface of the bezel. According to this exemplary embodiment, the recess may be configured to receive at least one contour in a receptacle of a mobile device cover.

### BRIEF DESCRIPTION OF THE DRAWINGS

FIG. 1 illustrates an exploded view of an exemplary wearable device disclosed herein.

FIG. 2 illustrates a profile view of another exemplary wearable device disclosed herein.

FIG. 3 illustrates an isometric view of an exemplary adaptor for an exemplary wearable device disclosed herein.

FIGS. 4-7 illustrate a plurality of views of an exemplary mobile device cover disclosed herein.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

The following detailed description is exemplary in nature and is not intended to limit the scope, applicability, composition or configuration of the invention in any way. Rather, the following description provides practical illustrations for implementing exemplary embodiments of the present invention.

In accordance with a number of exemplary embodiments of the present invention, a novel structure for a wristwatch capable of attaching to a mobile phone case or a mobile phone case capable of attaching to a wristwatch may be provided.

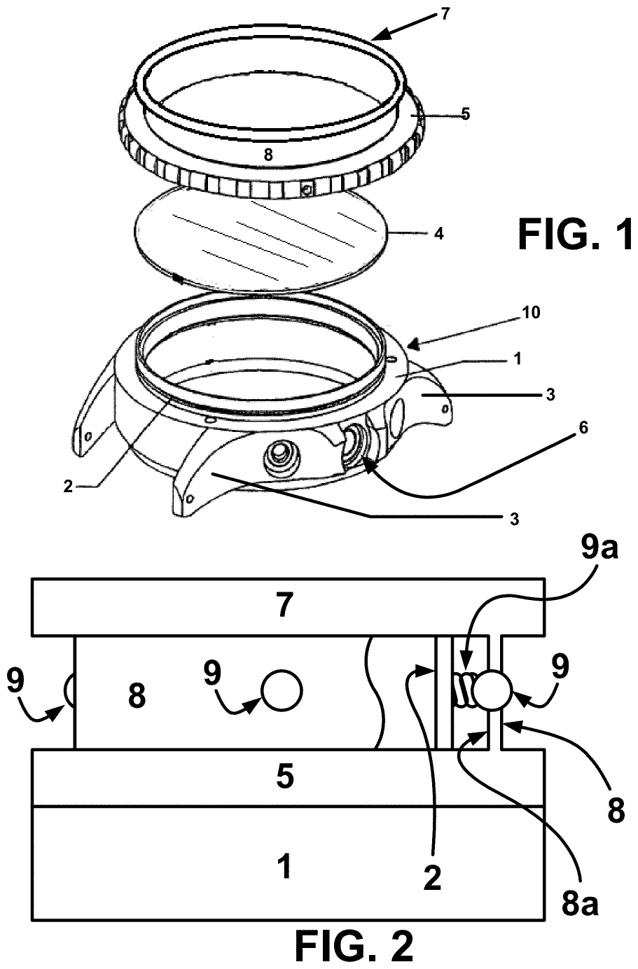

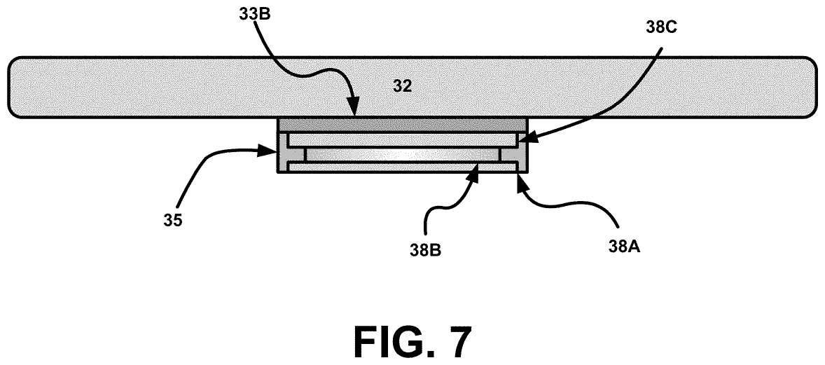

With reference to the exemplary embodiments illustrated by FIGS. 1-3, an exemplary wristwatch 10 may have a raised bezel 5 or other means for attaching to a mobile phone case 30. In another embodiment, which may be illustrated by FIGS. 4-7, an exemplary mobile phone case 30 may be depicted. The improved wristwatch 10 of the invention comprises a body 1. The body 1 of the wristwatch 10 comprises the case 2 of the watch 10, and the lugs 3, which project from the watchcase 2, and which may be used to secure the straps (not shown) to the watch case 2. The case 2 and lugs 3 can be made out of any appropriate material such as stainless steel, plastic, gold, platinum etc. The case 2 of the watch 10 holds the inner working parts of the watch (not shown). The case 2 of the watch 10 may be circular/round in shape. On top of the case 2 may be the crystal 4, which may be a translucent cover that can be made of glass, plastic, or other suitable materials, that protects the watch dial (not shown). The bezel 5 may be the ring around the crystal on the top portion of the watch 10 that holds the crystal portion 4 in place. On the right hand side of the case may be the crown 6, which may be used to set time and calendar functions. The bezel 5 and crown 6 can be the same material as the case 2 of the watch 10. The top portion 7 of the watch 10 comprising the bezel 5 can be raised so that it extends outward so that the portion 8 directly below the extended portion 7, may be recessed, and makes a space between the top portion 7 of the watch 10 and the remainder of the watch 10, e.g., bezel 5. The recess may be configured to receive the phone case therein.

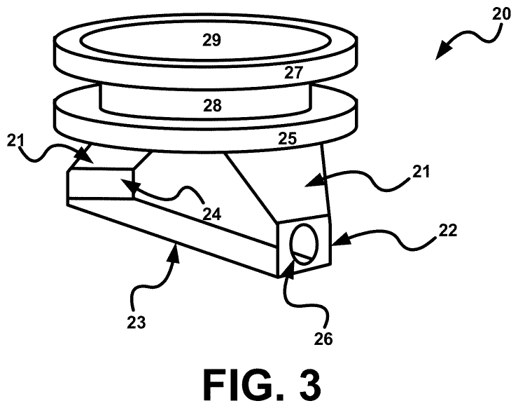

With reference to FIG. 2, an exemplary watch 10 may have a recess 8 containing certain retention mechanisms for retaining an exemplary mobile phone case attachment. For example, the exemplary embodiment of FIG. 2 may have a recess 8 with one or more bearing balls 9 sandwiched between case 2 and inside wall 8a of recess 8 while being spring biased against inside wall 8a using spring 9a. An aperture in recess 8 may allow bearing balls 9 to protrude just enough past wall 8a to contact a mobile phone attachment surface that would press against the balls to enable attachment and detachment as desired. While recess 8 may be shown with spring-bearing functionality, recess 8 may be able to couple to phone attachment systems using snap-fit engagements, friction fit, magnetic attachments, lock and/or key arrangements, or combinations of the same.

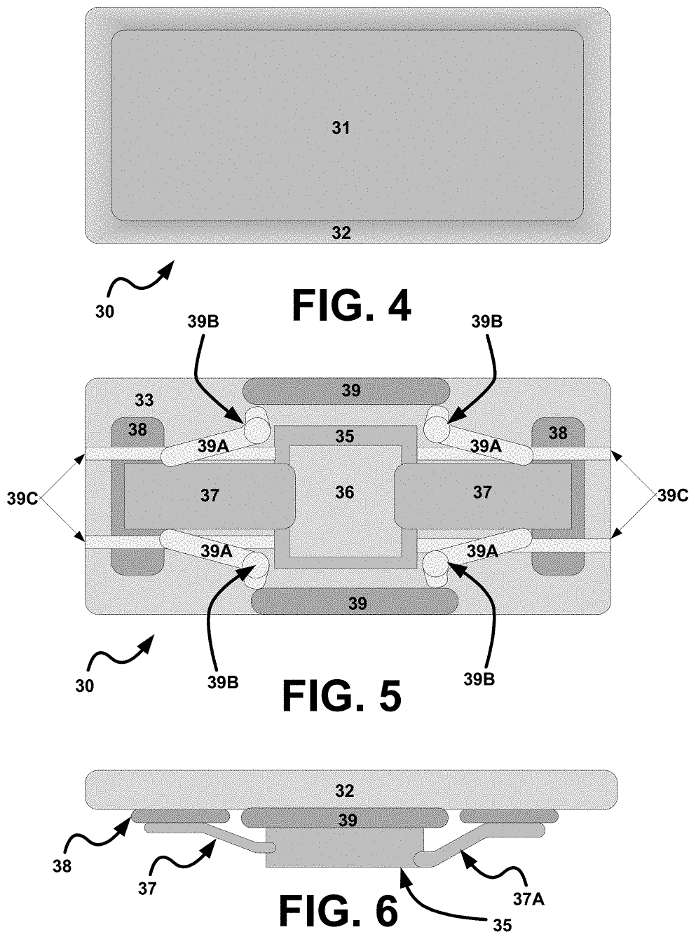

In an alternative embodiment, as may be illustrated by FIG. 3, a rigid elastomeric covering 20 may be fitted around a conventional watch so that the surfaces of covering 20 may be used like those of recess 8, upper portion 7 and bezel 5 on an exemplary watch 10. For example, an exemplary rigid elastomeric covering 20 may be anchored to a conventional watch via its lugs 4 and/or its crown 6 as follows. Covering 20 may have extensions 21 descending from bezel body 25. Attached to extensions 21 may be fingers 22 and 24 for grabbing the sides of a conventional watch. One or both fingers 22/24 may have an opening 26 for receiving either the crown 6 of an exemplary watch or the couplings for straps attached to lugs 3. A saddle 23 may ensure tight fitting of cover adaptor 20 to a conventional watch. In an exemplary embodiment, both fingers 22/24 may have an opening 26 spaced to receive the crown and at least one lug. In an alternative embodiment, fingers 22/24 may have an opening 26 that receives only lugs of the conventional watch. In a further embodiment, opening 26 may be used to fit around a conventional watch strap. In a yet further embodiment, a plurality of fingers 22 and plurality of fingers 24 may descend from bezel body 25 to attach to as many of crown 6, lugs 3, and straps as may be achievable based on needs. As attached, an exemplary cover 20 may have a recess 28 bounded by bezel body 25 and upper portion 27. According to this illustrative embodiment, the opening 29 through upper portion 27, recess 28, and bezel body 25 may permit a user to still see his or her watch when no mobile device may be attached to the same, but simultaneously permit for rapid engagement with the cover adaptor 20. While not shown, the recess 28 of the exemplary cover adaptor 20 may have the same or similar features of the recess 8 of an exemplary watch 10. Accordingly, an exemplary watch cover 20 may be designed from vulcanized rubber or other flexible yet resilient plastic (shore hardness of 85-95 durometer) to allow for robust connection to mobile device and, when not in a connected mode, ensure unencumbered use of the watch. For watches that do not have a crown 6, an audio jack or charger port in an exemplary phone may be a mounting point for an exemplary cover adaptor 20 and or phone case 30. In other words, rather than having an opening 26 for coupling to a crown 6, an exemplary finger 22 may have a micro-USB or USB-C shaped head to be inserted into the phone and retain it in accordance with the above. Alternatively, the finger 22 may have any appropriately shaped head to fit within an available opening in watch 10, such as a charging adaptor or audio jack.

The straps of the watch may comprise magnets on either end of each strap, and which secure the straps together so that the straps can be easily adjusted, so that one size fits all. The straps can be made out of any appropriate material. Other strap options include a buckle with grooves that allows for adjustment of the strap for fitting to the user's wrist.

In an exemplary embodiment illustrated in FIGS. 4 and 7, the specially designed mobile phone case 30 may comprise an inner housing 31 with a wall 32 that may be configured and dimensioned to fit securely around the entirety of a mobile phone and to protect the top, bottom, sides, and rear surfaces of the mobile phone. The mobile phone case can be made out of any appropriate material such as different type of plastics, etc. The mobile phone case 30 may have a window coupled to wall 32 on the front side of the case 30 allowing access to the full screen of the mobile phone. The rear protective case 33 may have a separate square shaped receptacle 35 that projects outward from the rear of the phone case 30. There may be a small cavity-like-pocket 36 that may be formed between the rear 33 of the phone case 30 and the outer-most portion of the receptacle 35. The small cavity 36 may bound rear 33 of phone case 30 or may alternatively bound a separate layer 33B that may cover only a portion of the rear 33 of the phone case 30. The outwardly projecting receptacle 35 may be positioned substantially in the middle of the rear 33 of phone case 30. Within the receptacle 35 on the rear 33 of the phone case 30 may be a lower contour 38C, a middle contour 38B, and an upper contour 38A. An exemplary contour 38A may have a complementary geometry to that of bezel 5 of watch 10 or bezel body 25 of adaptor 20. An exemplary contour 38B may be of a complementary geometry to recess 8 of watch 10 or recess 28 of adaptor 20. An exemplary contour 38C may be of a complementary geometry to top portion 7 of watch 10 or upper portion 27 of adaptor 20. As such, an exemplary receptacle 35 may be configured to receive and frictionally hold one or more surfaces of watch 10 and/or adaptor 20. Alternatively, other well-known attachment means can be used to secure the mobile phone case to the user's wristwatch.

In another exemplary embodiment illustrated by FIGS. 4-6, within an exemplary separate square shaped receptacle 35 on the rear 33 of the case 30, surrounding the receptacle 35 may be latching means 37 for securement to recess 8 or 28 of watch 10 or adaptor 20, respectively. An exemplary latching means 37 may be metal-reinforced plastic that may flex when top portion 7 of watch 10 or upper portion 27 of adaptor 20 may be pressed into contact therewith. Once the edges of latching means 37 are bent sufficiently to allow passage of portion 7/27, the latching means 37 may rely on its resilience to spring back into original form to grasp the recess 8 or 28. In an exemplary embodiment, latching means 37 may take the form of two longitudinal members that extend outward from a base 38. In another exemplary embodiment, a release mechanism 39 may be formed adjacent to base 38 to allow disengagement of latching means 37 from an exemplary recess 8/28. According to the exemplary embodiment of FIG. 5, an exemplary release mechanism 39 may be movable in a direction perpendicular to latching means 37 but by way of a spring-activated rocker arm 39A that pivots on set spring 39B, corresponding bases 38 may be slidable away from receptacle 35 and conjunctively, latch means 37. Accordingly, by pressing release mechanisms 39 towards the center of case 30, latch means 37 may be disengaged from the recess 8/28 into which it may have been lodged. In an alternative embodiment, two longitudinal members 37 may be parallel to one another with one clasp member 37A positioned on top of the receptacle 35, and the other clasp member 37 positioned on the bottom of the receptacle 35. The clasp members 37 may be joined together using their respective bases 38. According to this embodiment, the bases 38 may be used in conjunction with the release mechanisms 39 previously disclosed to detach the clasp members 37 from the cavity 35 and thereby release the watch 10 and/or adaptor 20 as the case may be.

As previously disclosed, a latching mechanism 37 may comprise a contoured face for friction fitting a recess 8 on watch 10 and another latching mechanism 37A may comprise a face shaped like an exemplary micro-USB or USB-C port for connection to an exemplary watch 10, such as for example, power adaptor connections for Android and Apple smart watches. As such, the latching mechanism 37A may be plugged into watch 10 first before friction fitting latch 37 about a recess 8 in the watch 10 and/or recess 28 if watch adaptor 20 may be employed.

When the improved wristwatch 10 of the invention may be worn on the user's wrist, the mobile phone, within the specially designed mobile phone case 30, can be attached on top of the wristwatch 10. Likewise, the improved mobile phone case 30 can be attached to the user's wristwatch 10. In one embodiment, the user can place the mobile phone within the case over the top portion of the wristwatch so that the receptacle on the back of the phone case may be over top of the face of the watch. With slight force the case of the watch engages with the receptacle 35 on the back of the phone case. As the phone case may be pushed on top of the face of the watch, the clasp mechanism within the cavity-like-portion tightens and secures the case of the watch in place. With a mobile case attached, the user may be able to move their hand about freely so that the wristwatch stays in place securely on the user's wrist, and the mobile phone, which may be attached on top of the wristwatch stays securely in place on the user's wrist. The user may be able to freely use their mobile phone as it may be held in place on their wrist. When the user wishes to release the mobile phone from the face of the watch, they can press downward on the base portion of the clasp mechanism (on the back of the mobile phone case), which will release the clasp members, and allow the mobile phone (within the case), to be taken off the wristwatch.

In certain embodiments, when the mobile phone may be attached to the wristwatch, the mobile phone, while still attached to the wristwatch, can rotate either partially or fully around the wristwatch in any direction so that the mobile phone can be positioned vertically or horizontally on the user's wrist/arm.

In certain embodiments the case of the wristwatch may be square or rectangular or had an irregular shape. The receptacle 35 on the back of the mobile phone case can match the shape as the case of the wristwatch so that the two pieces can attach with one another. Alternatively, receptacle 35 may have one or more contours 38A-C that allow for screw-like engagement with a bezel 5, portion 7, and recess 8 of a watch 10 or a complementary threading in recess 28 and portion 27 of adaptor 20.

In certain embodiments the wristwatch may be waterproof so that the user can attach the mobile phone (within the case) to the wristwatch, and wear the wristwatch, together with the mobile phone in the water, or outside when raining.

In certain embodiments the straps of the wristwatch may be interchangeable so that a user, depending on the desired look, can change the straps so that they may be metal, plastic, or leather.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A wearable mobile device attachment article, comprising:
a mobile device cover having a first face and a second face opposite the first face, the first face configured to provide access to the screen of a mobile device;
a receptacle projecting outwardly from the second face; and
a wearable article comprising at least one surface for frictionally engaging the mobile device cover, wherein the wearable article comprises at least one mechanism for communicating time to a user.

2. The wearable mobile device attachment article of claim 1, wherein the receptacle has a plurality of contours for frictional engagement with the wearable article.

3. The wearable mobile device attachment article of claim 1, wherein the mobile device cover has a plurality of latches for frictional engagement with the wearable article.

4. The wearable mobile device attachment article of claim 3, wherein the mobile device cover and the wearable article each have a plurality of contours for frictional engagement.

5. The wearable mobile device attachment article of claim 1, further comprising at least one release mechanism on the mobile device cover for disengagement with the wearable article.

6. The wearable mobile device attachment article of claim 2, further comprising at least one release mechanism on the mobile device cover for disengagement with the wearable article.

7. The wearable mobile device attachment article of claim 3, further comprising at least one release mechanism on the mobile device cover for disengagement with the wearable article.

8. The wearable mobile device attachment article of claim 1, wherein the at least one surface of the wearable article that frictionally engages the mobile device cover resides on an adaptor coupled to the wearable article.

9. The wearable mobile device attachment article of claim 8, wherein the receptacle has a plurality of contours for frictional engagement with the wearable article.

10. The wearable mobile device attachment article of claim 8, wherein the mobile device cover has at least one latch for frictional engagement with the wearable article.

11. A method of attaching a mobile device cover to a wearable article, comprising the steps of:
aligning a receptacle projecting from a rear of a mobile device cover with at least one surface on a wearable article; and
friction-fitting the receptacle over the at least one surface of the wearable article, wherein the wearable article is configured to communicate time to its wearer.

12. The method of claim 11, wherein the step of friction-fitting the receptacle over the at least one surface of the wearable article involves one of a latch on the mobile device cover, a contour in the receptacle, and a contour in the at least one surface on the wearable article.

13. The method of claim 12, wherein the step of friction-fitting the receptacle over the at least one surface of the wearable article involves the latch on the mobile device cover.

14. The method of claim 12, wherein the step of friction-fitting the receptacle over the at least one surface of the wearable article involves the contour in the receptacle.

15. The method of claim 12, wherein the step of friction-fitting the receptacle over the at least one surface of the wearable article involves the contour in the at least one surface on the wearable article.

16. A wearable article, comprising:
a body having time-communicating means;
a bezel coupled to the body having a surface projecting away from the body;
a top portion coupled to the bezel, wherein a recessed surface is located between the top portion and the surface of the bezel; and
at least one strap coupled to the body and configured to allow the wearable article to be worn,
wherein the top portion overhangs the recess and at least a portion of the surface of the bezel.

17. The wearable article of claim 16, wherein the top portion overhangs the recess and the entire surface of the bezel.

18. The wearable article of claim 16, wherein the recess is configured to receive at least one latch or at least one contour in a receptacle on a mobile device cover.

19. The wearable article of claim 18, wherein the recess is configured to receive a plurality of latches disposed on a mobile device cover.

20. The wearable article of claim 18, wherein the recess is configured to receive at least one contour in a receptacle of a mobile device cover.
